(19) United States
(12) Patent Application Publication
(10) Pub. No.: US 2008/0225757 A1
(43) Pub. Date: Sep. 18, 2008

(54) WEB-BASED INTERACTIVE LEARNING SYSTEM AND METHOD

(76) Inventor: Byron Johnson, Chicago, IL (US)

Correspondence Address: HOLLAND & KNIGHT LLP, 10 ST. JAMES AVENUE, 11th Floor, BOSTON, MA, 02116-3889, US

(21) Appl. No.: 11/830,045

(22) Filed: Jul. 30, 2007

Related U.S. Application Data
(60) Provisional application No. 60/894,535, filed on Mar. 13, 2007.

(51) Int. Cl. H04Q 11/00

(52) U.S. Cl. 370/260

(57) ABSTRACT

A system and method for interactive web based learning may include providing at least one teaching node accessible by at least one teacher, and providing at least one student node accessible by at least one student. A bidirectional live interface may be provided between the at least one teaching node and the at least one student node. The bidirectional live interface may enable the student node to receive at least one of an audio, a video or a text based communication from the at least one teaching node. The bidirectional live interface may also enable the at least one teaching node to receive at least one of an audio, a video or a text based communication from the at least one student node.

### CROSS-REFERENCE TO RELATED APPLICATIONS

This application claims the benefit of U.S. provisional patent application Ser. No. 60/894,535, filed Mar. 13, 2007, the entire disclosure of which is incorporated by reference.

### FIELD OF THE INVENTION

The present disclosure relates to learning tools, and more specifically to learning tools for a web-based interactive learning system and method.

### BACKGROUND

Many tools and programs exist for helping students learn. Often, these tools and programs involve attending special learning sessions with tutors. In today's busy world in which some students often work while studying toward a degree, there exists a need for such tools that are accessible from the home. Though some remote learning programs exist, they are often pre-recorded and do not involve a live learning experience.

It is often beneficial for a student to experience a live learning environment, even if the student cannot be present in the classroom. Thus, there exists a need for a live, remote learning program in which a student can participate in a live classroom, complete with discussion and teacher/peer interaction without having to be there.

### SUMMARY

The present invention provides a web-based interactive learning system and method.

In general, in one implementation, a method may include providing at least one teaching node accessible by at least one teacher. At least one student node accessible by at least one student may also be provided. A bidirectional live interface may be provided between the at least one teaching node and the at least one student node. The bidirectional live interface may enable the student node to receive at least one of an audio, a video or a text based communication from the at least one teaching node. Similarly, the bidirectional live interface may enable the at least one teaching node to receive at least one of an audio, a video or a text based communication from the at least one student node.

One or more of the following features may be included. The teaching node may reside in a live classroom environment including live students. The student node may be remotely located from the teaching node.

The at least one teaching node may include a signal configured to indicate that at least one student node is waiting to communicate over the bidirectional live interface.

In general, in another implementation, a computer program product residing on a computer readable medium may include a plurality of instructions stored on it. When executed by a processor, the computer program product causes the processor to perform operations including providing at least one teaching node accessible by at least one teacher. At least one student node accessible by at least one student may also be provided. A bidirectional live interface may be provided between the at least one teaching node and the at least one student node. The bidirectional live interface may enable the student node to receive at least one of an audio, a video or a text based communication from the at least one teaching node. Similarly, the bidirectional live interface may enable the at least one teaching node to receive at least one of an audio, a video or a text based communication from the at least one student node.

One or more of the following features may be included. The teaching node may reside in a live classroom environment including live students. The student node may be remotely located from the teaching node.

The at least one teaching node may include a signal configured to indicate that at least one student node is waiting to communicate over the bidirectional live interface.

In general, in another implementation, an interactive learning system may include at least one teaching node accessible by at least one teacher. At least one student node accessible by at least one student may be included. A bidirectional live interface may be provided between the at least one teaching node and the at least one student node. The bidirectional live interface may enable the student node to receive at least one of an audio, a video or a text based communication from the at least one teaching node. Similarly, the bidirectional live interface may enable the at least one teaching node to receive at least one of an audio, a video or a text based communication from the at least one student node.

One or more of the following features may be included. The teaching node may reside in a live classroom environment including live students. The student node may be remotely located from the teaching node.

The at least one teaching node may include a signal configured to indicate that at least one student node is waiting to communicate over the bidirectional live interface.

### BRIEF DESCRIPTION OF THE DRAWINGS

FIG. 1 is a diagrammatic view of a web-based interactive learning process coupled to a distributed computing network

FIG. 2 is a flowchart of a process executed by the web-based interactive learning process of FIG. 1.

### DETAILED DESCRIPTION

### System Overview:

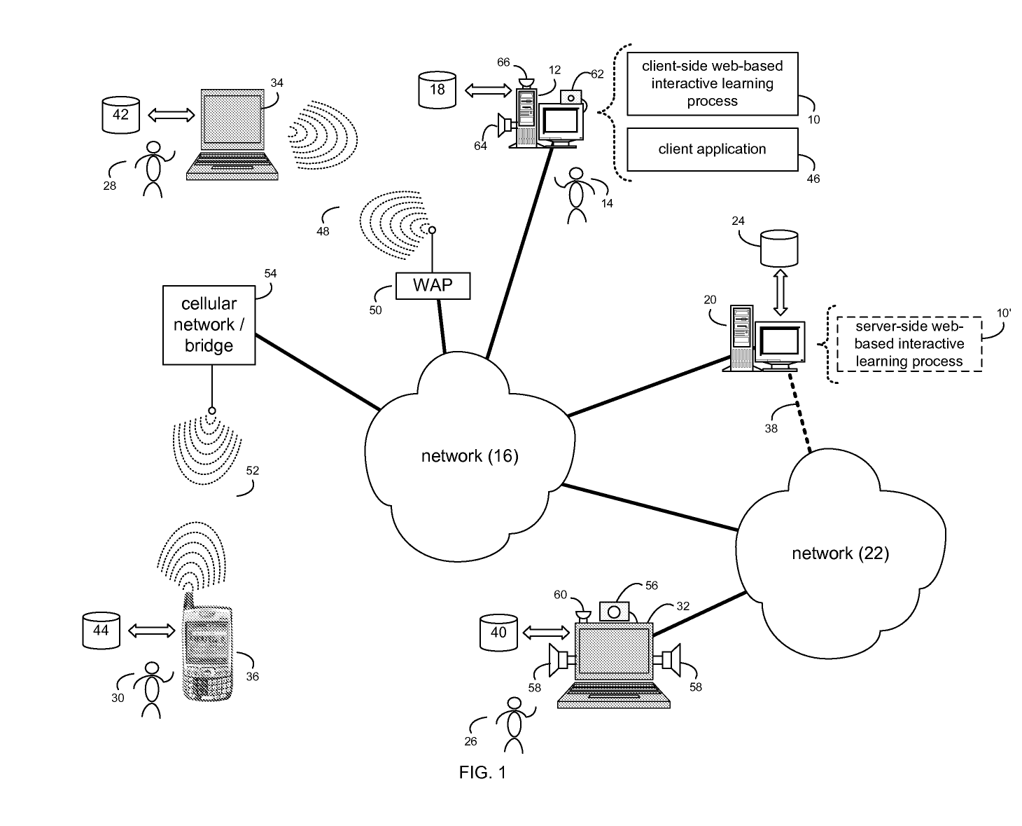

Referring to FIG. 1, there is shown a web-based interactive learning process 10 that may reside on and may be executed by a computing device (e.g., client computer 12). Examples of computing devices may include, but are not limited to, personal computers, laptop computers, notebook computers, and personal digital assistants, for example. As will be discussed below in greater detail, web-based interactive learning process 10 may enable a user 14 to select lessons for viewing in discreet quantities until the lesson is completed and may track the user's progress, reporting that progress to a third party.

Web-based interactive learning process 10 may be a client-side application that resides on and is executed by e.g., client computer 12, which may be connected to network 16 (e.g., the Internet). The instruction sets and subroutines of web-based interactive learning process 10, which may be stored on a storage device 18 coupled to client computer 12, may be executed by one or more processors (not shown) and one or more memory architectures (not shown) coupled to client computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, web-based interactive learning process 10′ (shown in phantom in FIG. 1) may be a server-based application. Server-side web-based interactive learning process 10′ may reside on and be executed by server computer 20, which may be coupled to network 16. Examples of server computer 20 may include, but are not limited to: a single server computer, a series of server computers, a mini computer, and a mainframe computer, for example. Server computer 20 may execute a network operating system, examples of which may include but are not limited to: Microsoft Windows XP Server™; Novell Netware™; or Redhat Linux™, for example.

Server computer 20 may execute a web server application, examples of which may include but are not limited to: Microsoft IIS™, Novell Webserver™, or Apache Webserver™, that allows for HTTP (i.e., HyperText Transfer Protocol) access to server computer 20 via network 16. Network 16 may be coupled to one or more secondary networks (e.g., network 22), examples of which may include but are not limited to: a local area network; a wide area network; or an intranet, for example.

The instruction sets and subroutines of server-side web-based interactive learning process 10′, which may be stored on a storage device 24 coupled to server computer 20, may be executed by one or more processors (not shown) and one or more memory architectures (not shown) coupled to data server 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the web-based interactive learning process may be a client-side application (e.g., client-side web-based interactive learning process 10), a server-side application (e.g., server-side web-based interactive learning process 10′), or a hybrid client-side/server-side application (e.g., using portions of both client-side web-based interactive learning process 10 and server-side web-based interactive learning process 10′). Accordingly, the manner in which the web-based interactive learning process 10, 10′ is accessed may vary depending on whether the web-based interactive learning process 10, 10′ is a client-side application, a server-side application, or a hybrid client-side/server-side application.

Client-side web-based interactive learning process 10 may be accessed by users 14, 26, 28, 30, e.g., directly through the device on which the client-side web-based interactive learning process is executed, namely client computer 12, notebook computer 32, laptop computer 34 and personal digital assistant 36, for example. For the purpose of clarity of the drawings, client-side web-based interactive learning process 10 is only shown associated with computer 12. Client-side web-based interactive learning process 10 may be associated with notebook computer 32, laptop computer 34 and personal digital assistant 36 in a corresponding manner. The instruction sets and subroutines of client-side web-based interactive learning process 10, which may be stored on a storage device (e.g., storage device 18, 40, 42, 44) coupled to the computing device (e.g., client computer 12, notebook computer 32, laptop computer 34 and personal digital assistant 36, respectively) executing client-side web-based interactive learning process 10, may be executed by one or more processors (not shown) and one or more memory architectures (not shown) incorporated into the computing device executing client-side web-based interactive learning process 10. Storage devices 18, 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Server-side web-based interactive learning process 10′ may be accessed by users 14, 26, 28, 30 through network 16 or through secondary network 22. Server computer 20 may be directly coupled to network 16, or may be coupled to network 16 through secondary network 22, as illustrated with phantom link line 38.

Client computer 12, notebook computer 32, laptop computer 34 and personal digital assistant 36 may access server-side web-based interactive learning process 10′, e.g., using a client application (e.g., client application 46) that may interface with server-side web-based interactive learning process 10′ and facilitate the bidirectional transfer of data between e.g., client computer 12 and data server 20. Client application 46 may be a web browser (e.g., Microsoft Internet Explorer™ and Netscape Navigator™, for example), a stand alone application, or an applet running within another program (e.g., Microsoft Internet Explorer™ and Netscape Navigator™, for example).

Client computer 12, notebook computer 32, laptop computer 34 and personal digital assistant 36 may each execute an operating system, examples of which may include but are not limited to Microsoft Windows™, Microsoft Windows Mobile™, Redhat Linux™, or a custom operating system.

The various computing devices (e.g., client computer 12, notebook computer 32, laptop computer 34 and personal digital assistant 36) may be directly or indirectly coupled to network 16 (or network 22). For example, client computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11 g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

### The Web-Based Interactive Learning Process:

As discussed above, the web-based interactive learning process 10 may be a client-side application, a server-side application, or a hybrid client-side/server-side application. Accordingly, the following disclosure is applicable to all variants of web-based interactive learning process 10.

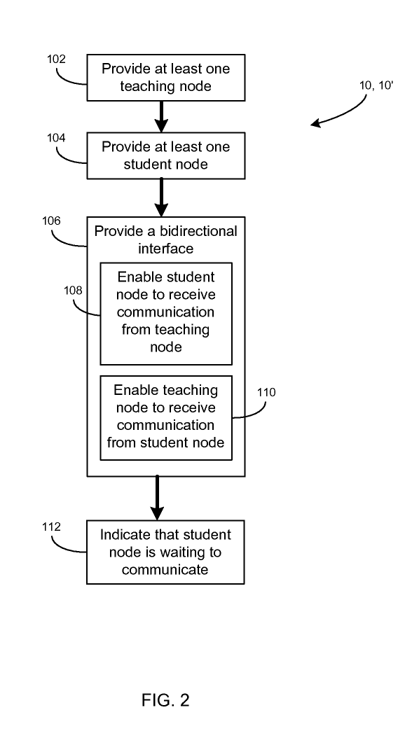

Referring also to FIG. 2, web-based interactive learning process 10 may provide 102 at least one teaching node, e.g., notebook computer 32, accessible by at least one teacher, e.g., user 26. As such, the teaching node may include a computing device (i.e., notebook computer 32), which may include one or more media input/output devices, e.g., web-camera 56, audio components, such as speakers 58 and microphone 60, and a real-time messaging system (not shown).

Web-based interactive learning process 10 may also provide 104 at least one student node (e.g., client computer 12) accessible by at least one student (e.g., user 14). The student node may include a computing device (i.e., client computer 12), which may include one or more media input/output devices, e.g., web-camera 62, audio components, such as speakers 64 and microphone 66, and a real-time messaging system (not shown).

A bidirectional live interface may be provided 106 between the at least one teaching node (notebook computer 32) and the at least one student node (client computer 12), e.g., via network 16 and/or network 22. The bidirectional live interface may enable 108 the student node to receive at least one of an audio, a video or a text based communication from the at least one teaching node. The audio, video, or text based communication from the teaching node may be input by the teacher, e.g., using web camera 56, microphone 60, or real-time messaging system, for example. Similarly, the bidirectional live interface may enable 110 the at least one teaching node to receive at least one of an audio, a video or a text based communication from the at least one student node. The audio, video, or text based communication from the student may be input by the student using, for example, web camera 62, microphone 66, or real-time text messaging system associated with client computer 12. For example, a live video stream of a teacher teaching a lesson may be captured by web camera 56 and may be transmitted through the bidirectional live interface, e.g., via network 16 and/or network 22, to a student (i.e., user 14) located outside of the teacher's classroom. The live video stream of the teacher may be rendered by client computer 12. For example, a video component of the live video stream may be rendered by client computer 12, and an audio component of the live video stream may be rendered by speakers 64. The student may ask questions and offer answers in response to the lesson, for example, via a video stream captured by web camera 62, audio captured by microphone 66, text messaging using real-time text messaging system. The student generated questions and/or answers may be communicated to the teaching node (notebook computer 32) through the bidirectional live interface (e.g., provided over network 16 and/or network 22) and rendered as text, video, and/or audio communication by one or more of notebook computer 32, and speakers 58.

The teaching node may reside in a live classroom environment including live students. For example, the teaching node may be used in a live classroom for a student who is unable to attend due to illness or injury. In this way, the student would not have to miss his regular classes though he is unable to physically attend. Similarly, the teaching node may be used in a live classroom for a student who is easily distracted by the other students in the room or who has behavioral issues. In this way, a student who learns best when physically removed from the classroom may still participate in the lesson and benefit from the contributions of classmates without the drawbacks of physical attendance.

Alternatively, the teaching node may reside in a distance learning classroom that does not include live students. For example, a teacher may present a lesson from his office or from an empty classroom for students who are participating in a distance learning program. In this way, each student node may be remotely located from the teaching node. The students may interact with the teacher as if they were present in the classroom through the bidirectional live interface.

The at least one teaching node may include a signal configured to indicate 112 that at least one student node is waiting to communicate over the bidirectional live interface. Unlike a traditional classroom setting where students can raise their hand when they have a question or an answer, remote students may notify the teacher that they have something to offer by activating the signal in the teaching node. The signal in the teaching node may be activated by a student pressing a preprogrammed key on the keyboard, by clicking on a button on a user interface on the computing device or sending a message to the teacher, the receipt of which would activate the signal.

A number of implementations have been described. Nevertheless, it will be understood that various modifications may be made. Accordingly, other implementations are within the scope of the following claims.

What is claimed is:

1. A method comprising:
providing at least one teaching node accessible by at least one teacher;
providing at least one student node accessible by at least one student; and
providing a bidirectional live interface between the at least one teaching node and the at least one student node, the bidirectional live interface enabling the student node to receive at least one of an audio, a video or a text based communication from the at least one teaching node, and enabling the at least one teaching node to receive at least one of an audio, a video or a text based communication from the at least one student node.

2. The method of claim 1, wherein the teaching node resides in a live classroom environment including live students.

3. The method of claim 1, wherein the student node is remotely located from the teaching node.

4. The method of claim 1, wherein the at least one teaching node includes a signal configured to indicate that at least one student node is waiting to communicate over the bidirectional live interface.

5. A computer program product residing on a computer readable medium having a plurality of instructions stored thereon which, when executed by a processor, cause the processor to perform operations comprising:
providing at least one teaching node accessible by at least one teacher;
providing at least one student node accessible by at least one student; and
providing a bidirectional live interface between the at least one teaching node and the at least one student node, the bidirectional live interface enabling the student node to receive at least one of an audio, a video or a text based communication from the at least one teaching node, and enabling the at least one teaching node to receive at least one of an audio, a video or a text based communication from the at least one student node.

6. The computer program product of claim 5, wherein the teaching node resides in a live classroom environment including live students.

7. The computer program product of claim 5, wherein the student node is remotely located from the teaching node.

8. The computer program product of claim 5, wherein the at least one teaching node includes a signal configured to indicate that at least one student node is waiting to communicate over the bidirectional live interface.

9. An interactive learning system comprising:
at least one teaching node accessible by at least one teacher;
at least one student node accessible by at least one student; and
a bidirectional live interface between the at least one teaching node and the at least one student node, the bidirectional live interface enabling the student node to receive at least one of an audio, a video or a text based communication from the at least one teaching node, and enabling the at least one teaching node to receive at least one of an audio, a video or a text based communication from the at least one student node.

10. The interactive learning system of claim 9, wherein the teaching node resides in a live classroom environment including live students.

11. The interactive learning system of claim 9, wherein the student node is remotely located from the teaching node.

12. The interactive learning system of claim 9, wherein the at least one teaching node includes a signal configured to indicate that at least one student node is waiting to communicate over the bidirectional live interface.
